(19) United States
(12) Patent Application Publication
(10) Pub. No.: US 2017/0147871 A1
(43) Pub. Date: May 25, 2017

(54) FATIGUE-WARNING SYSTEM

(71) Applicant: Primax Electronics Ltd., Taipei (TW)

(72) Inventors: YING-CHE TSENG, Taipei (TW); CHENG-YI TSAI, Taipei (TW)

(21) Appl. No.: 14/992,878

(22) Filed: Jan. 11, 2016

(30) Foreign Application Priority Data
Nov. 20, 2015 (TW) 104138524

(51) Int. Cl. G06K 9/00; G06F 3/02; G08B 21/06; G06F 3/01

(52) U.S. Cl. CPC G06K 9/00315; G06K 9/00255; G06F 3/015; G06F 3/021; G06F 3/012; G08B 21/06

(57) ABSTRACT

The present invention discloses a fatigue-warning system, including a camera device, a sensor, a processor, and at least one warning unit. The camera device captures a facial image of a user; the sensor senses physiological information of the user; the processor receives a movement image and the physiological information and generates a drive signal; and the warning unit receives the drive signal to produce a warning signal.

### FIELD OF THE INVENTION

The present invention relates to a warning system, and in particular, to a fatigue-warning system.

### BACKGROUND OF THE INVENTION

Modern people are increasingly dependent on using mobile electronic devices, especially devices such as smart phones, tablet computers, or notebook computers. No matter in working, querying information, shopping, entertaining, or contacting with others, most people conducts real-time operation by using mobile electronic software and hardware. The convenience and rapidness causes the modern people to spend a lot of time operating the electronic device every day. However, using the electronic device for a long time easily causes fatigue, and may more easily cause various eye, brain, neuroarthritic, or even endocrine abnormalities or diseases, and therefore, it is necessary to rest properly to avoid over fatigue.

However, when people concentrate on using the mobile electronic devices, it is always hard for them to spontaneously suspend using the mobile electronic devices. Therefore, a case in which a reminding device is added to an electronic device is disclosed in the prior art. The reminding device detects usage time of a user, and produces a warning when the user uses the electronic device for an excessively long time. However, different users have different physical states, the method of determining, only according to the usage time, whether to produce a warning signal cannot clearly correspond to whether the user is in a fatigue state. Therefore, a novel method is needed to solve the problem of the conventional warning system.

### SUMMARY OF THE INVENTION

To solve the problem of the prior art, an objective of the present invention is to provide a fatigue-warning system, which is disposed in a mobile electronic device, and detects a fatigue degree by using elements of the mobile electronic device together with a wearable device, to clearly detect whether a user is in a fatigue state, and the warning system is portable and can produce a warning precisely.

To achieve the foregoing objective, a fatigue-warning system provided in the present invention includes:
a camera device, configured to capture a facial image of a user;
a wearable device, disposed on a surface of the body of the user, where the wearable device includes:
a sensor, configured to sense a physiological signal of the user and generate a dynamic numerical value;
a processor, configured to generate a static numerical value according to the facial image, calculate the static numerical value and the dynamic numerical value, and generate a drive signal when a sum of the static numerical value and the dynamic numerical value reaches a fatigue standard value; and
at least one warning unit, configured to receive the drive signal, generate a warning signal, and send the warning signal to the user.

Preferably, when the static numerical value and the dynamic numerical value are added to generate a fatigue numerical value, and the fatigue numerical value reaches the fatigue standard value, the processor sets the static numerical value, the dynamic numerical value, and the fatigue numerical value to zero and recalculates the fatigue numerical value, and when the number of times that the fatigue numerical value reaches the fatigue standard value within a preset time exceeds the standard number of times, the processor generates the drive signal.

Preferably, the facial image is a facial expression and a head movement of the user.

Preferably, the facial expression includes a closed state of eyes, whether there is a yawn, or a swing state of the head.

Preferably, the sensor detects the pulse of the heart, or the blood flow velocity, or the number of times of hand vibrations of the user, when the pulse of the heart, or the blood flow velocity, or the number of times of hand vibrations of the user is less than a normal physiological value, the sensor generates the dynamic numerical value.

Preferably, the processor is disposed in an electronic device and the wearable device is in signal connection with the electronic device.

Preferably, the electronic device is a tablet computer, a notebook computer, or a desktop computer.

Preferably, the warning unit is disposed in the electronic device or the wearable device.

Preferably, the warning unit is a buzzer, a vibrator, or a micro electric shock unit.

Preferably, the desktop computer includes a separated keyboard and the camera device is disposed on the keyboard.

### BRIEF DESCRIPTION OF THE DRAWINGS

FIG. 1 is a schematic block diagram of a preferred embodiment of a system according to the present invention; and

FIG. 2 is a schematic diagram of a using state of a preferred embodiment according to the present invention.

### DETAILED DESCRIPTION OF THE PREFERRED EMBODIMENT

Illustrations are made in the following by using preferred embodiments of the present invention with reference to the accompanying drawings.

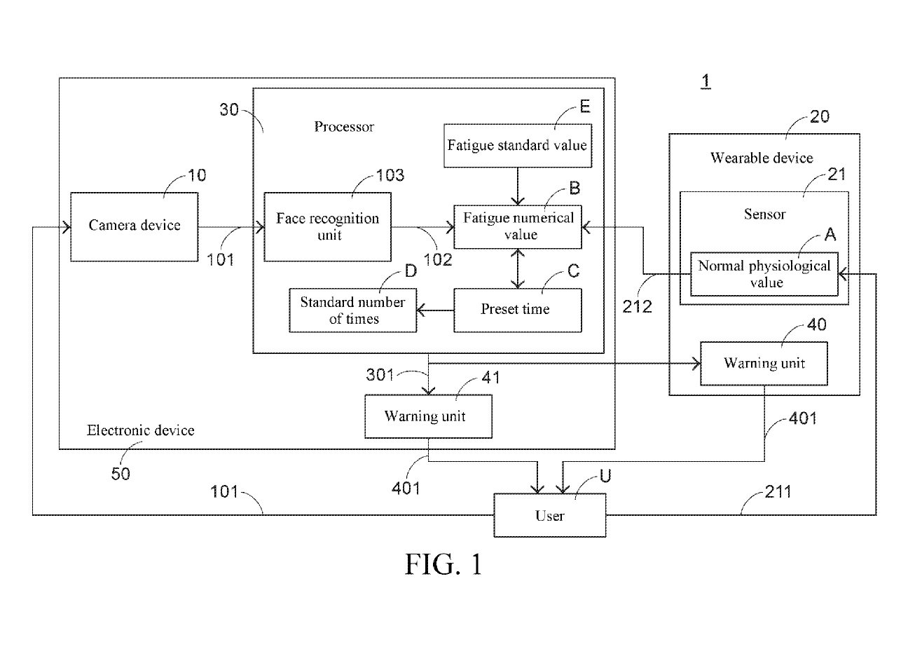

FIG. 1 shows a schematic block diagram of a preferred embodiment according to the present invention. A fatigue-warning system 1 of the present invention detects a fatigue degree of a user U when the user U uses an electronic device 50, and provides warning in time. The fatigue-warning system 1 of the present invention includes a camera device 10, a wearable device 20, and a processor 30. The wearable device 20 includes a sensor 21 and a warning unit 40. In the embodiment of FIG. 1, the camera device 10 and the processor 30 are disposed in the electronic device 50. Preferably, another warning unit 41 may also be disposed in the electronic device 50.

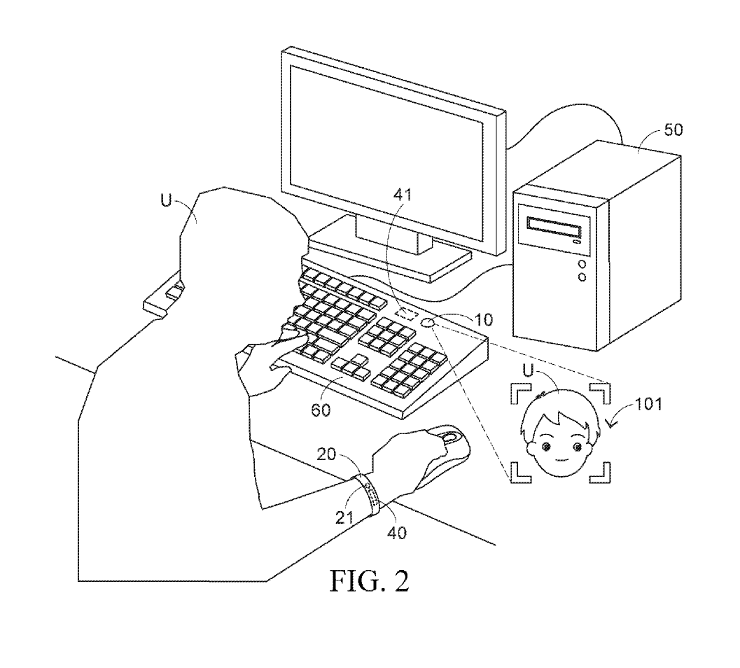

FIG. 2 shows a schematic diagram of the user U wearing the wearable device 20 and using the electronic device 5. When the user operates the electronic device 50, the camera device 10 captures a facial image 101 of the user U and sends the image to the processor 30. The facial image 101 is, for example, a facial expression and a head movement of the user U, including whether the eyes are closed, whether the user yawns, or whether the head swings or droops. When the user has the foregoing expressions and movements, it generally indicates that the user U is in a fatigue state. The processor 30 generates a static numerical value 102 according to the facial image 101. Definitely, in order to more clearly determine whether the user is indeed in a fatigue state, so as to avoid that improper production of a warning signal disturbs the user, the present invention further provides the wearable device 20 to detect a physiological signal of the user. As shown in FIG. 2, the wearable device 20 is disposed on the surface of the body of the user U, for example, is worn on the wrist.

The sensor 21 may detect a physiological signal 211 sent by the user U, where the physiological signal 211 is, for example, physiological information that is objective enough to show that the user U feels fatigue, such as the pulse of heart beat, the blood flow velocity, or the number times of hand vibrations of the user U. After receiving the physiological signal 211, the sensor 21 generates a dynamic numerical value 212 and transmits the value to the processor 30. The processor 30 calculates the static numerical value 102 and the dynamic numerical value 212 to determine whether to enable the warning unit 40 to produce a warning signal. In this embodiment, the processor 30 conducts totaling on the dynamic numerical value 212 and the static numerical value 102, generates a drive signal 301 when a sum of the two numerical values reaches a fatigue standard value E, and sends the signal to the warning unit 40 and the warning unit 41. The warning unit 40, for example, a vibrator, receives the drive signal 301 to generate a warning signal 401, for example, vibrate the user U. The warning function is implemented when the user feels the vibration on the hand. Or, the warning unit 40 may be a micro electric shock unit that generates a slight shock effect. The warning effect is achieved when the user feels a shock effect on the hand. The warning unit 41 may be a buzzer, configured to generate a warning sound to achieve the warning effect.

Further, a normal physiological value A is preset for the sensor 21, and the processor 30 further includes a face recognition unit 103, a fatigue numerical value B, a preset time C, and the standard number D of times. The normal physiological value A is an average value of physiological information when the human body is in a normal waking state, including physiological information data showing that the human body is in a waking state, for example, the pulse of heart beat is over 60 per minute, the blood flow velocity reaches 65 milliliter per second, or there are obvious sharp vibrations of the hand. When the physiological signal 211 of the user U does not reach the normal physiological value A, the sensor 21 generates a dynamic numerical value 212 when any item of the physiological signal 211 does not reach the normal physiological value A. The normal physiological value A may be a built-in default value, or may be adjusted autonomously by the user U. Moreover, the face recognition unit 103 is configured to recognize the facial image 101 captured by the camera device 10. When it is found in the facial image 101 that there are actions, for example, eyes are closed for over 5 seconds, the user yawns, the head slightly and regularly swings or the head droops, the face recognition unit 103 generates a static numerical value 102 when detecting any action. The fatigue numerical value B is a sum of the dynamic numerical value 212 and the static numerical value 102. When the fatigue index B reaches the fatigue standard value E, the processor 30 determines that the user U is in a fatigue state. Moreover, for precise determining, the processor 30 calculates the number of times that the fatigue numerical value B reaches the fatigue standard value E, and when the fatigue numerical value B reaches the fatigue standard value E, the processor sets the static numerical value 102, the dynamic numerical value 212 and the fatigue numerical value B to zero and recalculates the fatigue numerical value B by totaling the dynamic numerical value and the static numerical value, where a preset time C records the number of times that after the fatigue numerical value B is set to zero and recalculated, the fatigue numerical value B reaches the fatigue standard value E. The standard number D of times is a number index determining fatigue of the human body. In other words, when the number of times, recorded by the processor 30, that the fatigue numerical value B reaches the fatigue standard value E within the preset time C reaches D, it is determined that the user is in a fatigue state.

A running state of the system is described by using an example in which the user operates an electronic device 50. Referring to FIG. 2, the electronic device 50 shown in FIG. 2 is a desktop computer, and the electronic device of this system may also be, for example, a tablet computer, a notebook computer, or a smart phone. As shown in FIG. 2, the user U wears the wearable device 20 and uses the desktop computer. The desktop computer includes a separated keyboard 60, and the camera device 10 is disposed on the keyboard 60. The warning unit 40 and the warning unit 41 are disposed in the wearable device 20 and the keyboard 60. In this embodiment, the face recognition unit 103 in the processor 30 uses two actions of closing eyes and yawning in the facial image 101 as recognition indexes. The physiological signal 211 of the user U used in this example includes the pulse of heart beat, the blood flow velocity, and the vibration of the hand. Moreover, in this example, the preset time C is 5 minutes, the standard number D of times is 3, and the fatigue standard value is 3. When it is found through the facial expression of the user U that the user U closes eyes or yawns, the processor 30 adds 1 to the static numerical value 102. When the sensor 21 of the wearable device 20 detects that the pulse of the heart beat, the blood flow velocity, or the vibration of the hand of the user U does not reach the normal physiological value A, 1 is added to the dynamic numerical value 212, and the dynamic numerical value 212 is transmitted to the processor 30. The processor 30 adds the static numerical value 102 and the dynamic numerical value 212 to generate the fatigue numerical value B. For example, when the user generates a yawn expression for once, 1 is added to the static numerical value 102, and because the sensor 21 does not detect an abnormal physiological phenomenon, the dynamic numerical value 212 is 0. In this case, the fatigue numerical value B is 1. Then, when the sensor 21 detects that the pulse of the heart beat of the user U is abnormal, 1 is added to the dynamic numerical value 212, and in this case, the fatigue numerical value B becomes 2. Then, when the user has the yawn expression, 1 is further added to the static numerical value 102 and the static numerical value becomes 2, and in this case, the fatigue numerical value B becomes 3. Because the fatigue numerical value B has reached the preset fatigue standard value 3, the fatigue numerical value B is set to zero, and numerical values of the static numerical value 102 and the dynamic numerical value 212 are both set to zero. Thereafter, when the user has the yawn expression for 3 times successively, 1 is added to the static numerical value 102 successively, and the static numerical value becomes 3, so that the fatigue numerical value B becomes 3 again, and numerical values of the fatigue numerical value B, the static numerical value 102, and the dynamic numerical value 212 are set to zero again. Likewise, when the numerical value of the fatigue numerical value B is accumulated to 3 for the third time within 5 minutes after the fatigue numerical value B becomes 3 for the first time, the processor 30 generates the drive signal 301 and sends the signal to the warning unit 40, so as to generate a warning signal 401 to the user to remind the user to have a rest.

In conclusion, the fatigue-warning system provided in the present invention is disposed in an electronic device, and detects the fatigue degree by using elements of the electronic device together with a wearable device, so that it can be clearly detected whether the user is in a fatigue state, and the system is portable and can produce a warning more precisely.

The foregoing are merely preferred embodiments of the present invention, rather than limiting that the present invention can be implemented only according to the embodiments, or limiting the scope of the present invention. Inventions made without departing from the techniques and spirits of the present invention shall all fall within the protection scope of the present invention.

What is claimed is:

1. A fatigue-warning system, comprising:
a camera device, configured to capture a facial image of a user;
a wearable device, disposed on a surface of the body of the user, wherein the wearable device comprises:
a sensor, configured to sense a physiological signal of the user and generate a dynamic numerical value;
a processor, configured to generate a static numerical value according to the facial image, calculate the static numerical value and the dynamic numerical value, and generate a drive signal when a sum of the static numerical value and the dynamic numerical value reaches a fatigue standard value; and
at least one warning unit, configured to receive the drive signal, generate a warning signal, and send the warning signal to the user.

2. The fatigue-warning system according to claim 1, wherein when the static numerical value and the dynamic numerical value are added to generate a fatigue numerical value, and the fatigue numerical value reaches the fatigue standard value, the processor sets the fatigue numerical value, the static numerical value, and the dynamic numerical value to zero and recalculates the fatigue numerical value, and when the number of times that the fatigue numerical value reaches the fatigue standard value within a preset time exceeds a standard number, the processor generates the drive signal.

3. The fatigue-warning system according to claim 1, wherein the facial image is a facial expression and a head movement of the user.

4. The fatigue-warning system according to claim 3, wherein the facial expression comprises a closed state of eyes, whether there is a yawn, or a swing state of the head.

5. The fatigue-warning system according to claim 1, wherein the sensor detects the pulse of the heart, or the blood flow velocity, or the number of times of hand vibrations of the user, when the pulse of the heart, or the blood flow velocity, or the number of times of hand vibrations of the user is less than a normal physiological value, the sensor generates the dynamic numerical value.

6. The fatigue-warning system according to claim 1, wherein the processor is disposed in an electronic device and the wearable device is in signal connection with the electronic device.

7. The fatigue-warning system according to claim 6, wherein the electronic device is a tablet computer, a notebook computer, or a desktop computer.

8. The fatigue-warning system according to claim 6, wherein the warning unit is disposed in the electronic device or the wearable device.

9. The fatigue-warning system according to claim 1, wherein the warning unit is a buzzer, a vibrator, or a micro electric shock unit.

10. The fatigue-warning system according to claim 6, wherein the desktop computer comprises a separated keyboard and the camera device is disposed in the keyboard.
